(19) United States
(12) Patent Application Publication
(10) Pub. No.: US 2013/0194785 A1
(43) Pub. Date: Aug. 1, 2013

(54) Faith Box

(71) Applicant: Donnie Leo Brill, Urbandale, IA (US)

(72) Inventor: Donnie Leo Brill, Urbandale, IA (US)

(21) Appl. No.: 13/359,780

(22) Filed: Jan. 27, 2012

(51) Int. Cl. F21V 33/00

(52) U.S. Cl. 362/121

(57) ABSTRACT

The Faith Box is made in four designs. Each of the four designs is a wooden stained box. These range from 2.25″ to 5.25″ tall, 8″ wide and 8″ deep. There is a shelf approximately 1.5 inches down from the top, which creates a four sided cavity 1.5 inches deep. The cavity is partially filled by white sand and six irregularly shaped stones. A LED light is centered and angled upward 45 degrees to shine on the front main cross. This LED light illuminates the crosses which reflect up on the background. The size of the reflection on the wall vanes according to the distance the Faith Box is located from the wall.

### CROSS REFERENCE TO RELATED APPLICATIONS (IF ANY)

N/A

### STATEMENT OF FEDERALLY SPONSORED RESEARCH/DEVELOPMENT (IF ANY)

N/A

### NAMES OF PARTIES TO A JOINT RESEARCH AGREEMENT

N/A

### SEQUENCE LISTING

Application
Application Data Sheet
Specification
Claims
Drawings
Executed Oath or declaration

### BACKGROUND OF THE INVENTION

Invention was inspired from my faith. I just started drawing crosses and created a box for them to sit in. I feel this invention will be a means to share my faith with others.

### BRIEF SUMMARY OF THE INVENTION

Wooden stained box of Poplar wood, 2.25-5.25″ tall, 8″ wide and 9″ deep. A shelf approximately 1.5 inches down from the top which also creates a four sided cavity 1.5 inches deep. The cavity is partially filled by white sand and six irregularly shaped stones. A LED light is centered and angled upward 45 degrees to shine on the front main cross. This LED light illuminates the crosses which reflect up on the background. The size of the reflection on the wall varies according to the distance the Faith Box is located from the wall.

### BRIEF DESCRIPTION OF THE SEVERAL VIEWS OF THE DRAWINGS

Faith Box—Basic—View 1, front view shows the basic wooden box with the three crosses. View 2 is the cross section/cutaway view of the wooden box and crosses. It further shows the sand, stones, placement of the LED light, battery holder, and wire placement.
Faith Box—Bible Slot—View 1, front view shows the wooden, stained box with the opening for the Bible. View 2 is the cross section/cutaway view of the wooden box and crosses. It further shows the sand, stones, placement of the LED light, battery holder, and wire placement.
Faith Box—Drawer—View 1, front view shows the wooden, stained box with a pull knob for the drawer. View 2 is the cross section/cutaway view of the wooden box and crosses. It further shows the sand, stones, placement of the LED light, battery holder, and wire placement.
Faith Box—Drawer Slot—View 1, front view shows the wooden, stained box with the drawer and slot for the Bible. View 2 is the cross section/cutaway view of the wooden box and crosses. It further shows the sand, stones, placement of the LED light, battery holder, and wire placement.

### DETAILED DESCRIPTION OF THE INVENTION

Wooden stained boxes of Poplar wood ranging from 2.25″ to 5.25″ tall, 8″ wide and 8″ deep. (Claims will describe size of each of the four Faith Boxes). Each Faith Box includes a shelf lower than the top of the box, which also creates a four sided cavity 1.5 inches deep. In the cavity one cup of white sand is the base, and six (6) irregularly shaped stones of various size, texture, and color are placed in the sand.

Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.

A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.

Electrical component for the LED light consists of:
LED light
10 ohm resistor
22 gauge wire
AA battery holder
On/off switch

This LED light illuminates the crosses which reflect up on the background. The size of the reflection on the wall varies according to the distance the Faith Box is located from the wall.

### BRIEF DESCRIPTION OF DRAWINGS VIEWS

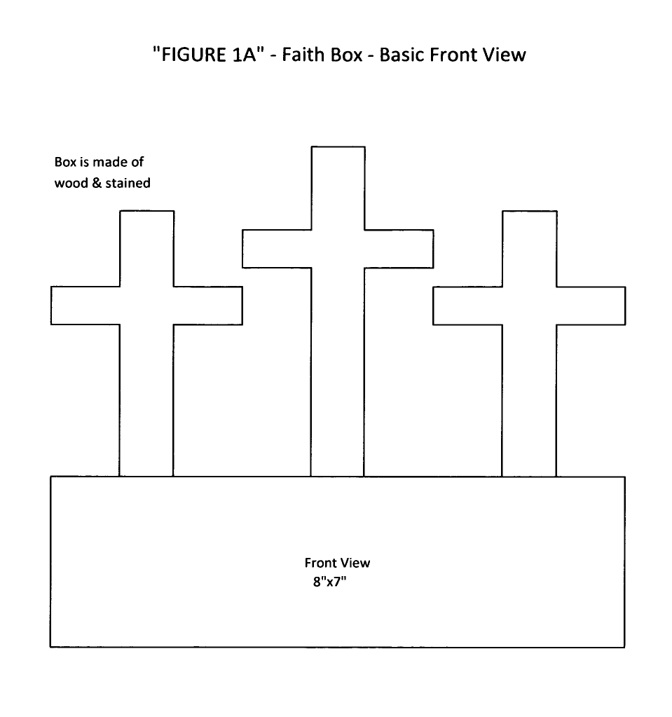

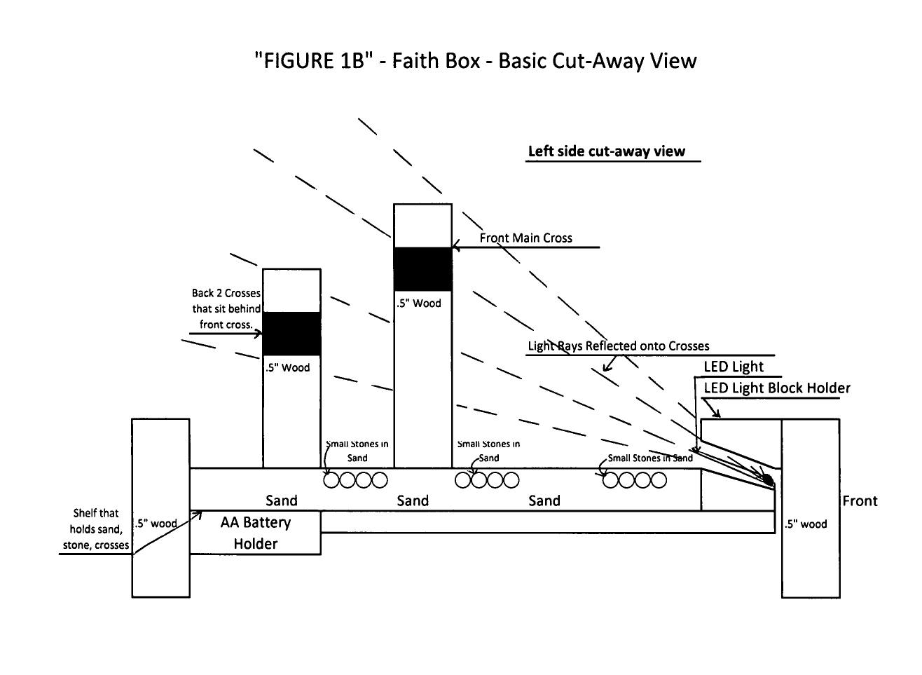

“FIG. 1A”—Faith Box—Basic Front View:

### Wooden Stained Box

Poplar wood
2.25″ tall×8″ wide×9″ deep

Includes a shelf approximately 1.5 inches down from the top which also creates a four sided cavity 1.5 inches deep.

In the cavity one cup of white sand is the base, and six (6) irregularly shaped stones of various size, texture, and color are placed in the sand.

Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.

A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.

Electrical component for the LED light consists of:
LED light
10 ohm resistor
22 gauge wire
AA battery holder
On/off switch

This LED light illuminates the crosses which reflect up on the background. The size of the reflection on the wall varies according to the distance the Faith Box is located from the wall.

“FIG. 1B”—Faith Box—Basic Cut-Away View:

Description is same as FIG. 1A, but this view shows the left side cut-away/cross section view. Also, shown is the direction the LED light is on the cross, the battery holder and wiring for the LED light under the base.

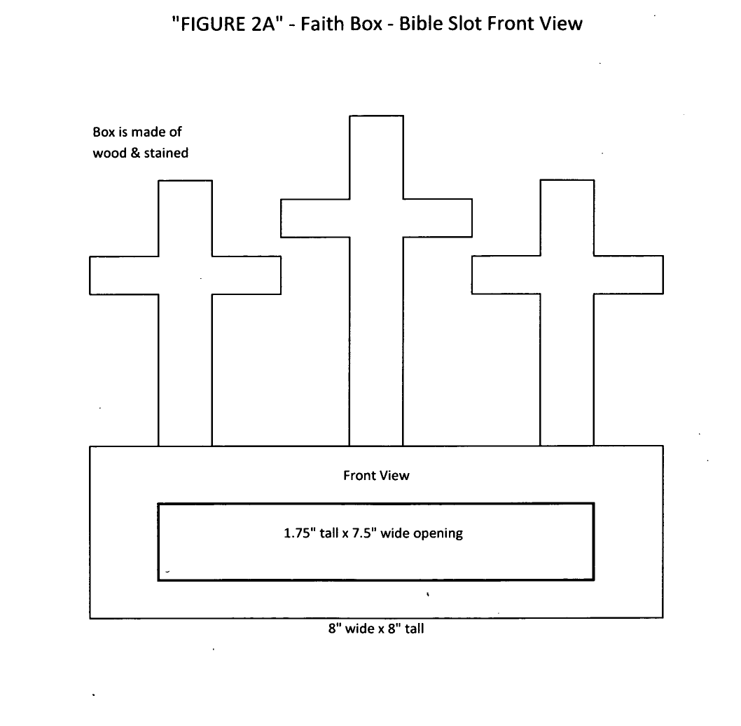

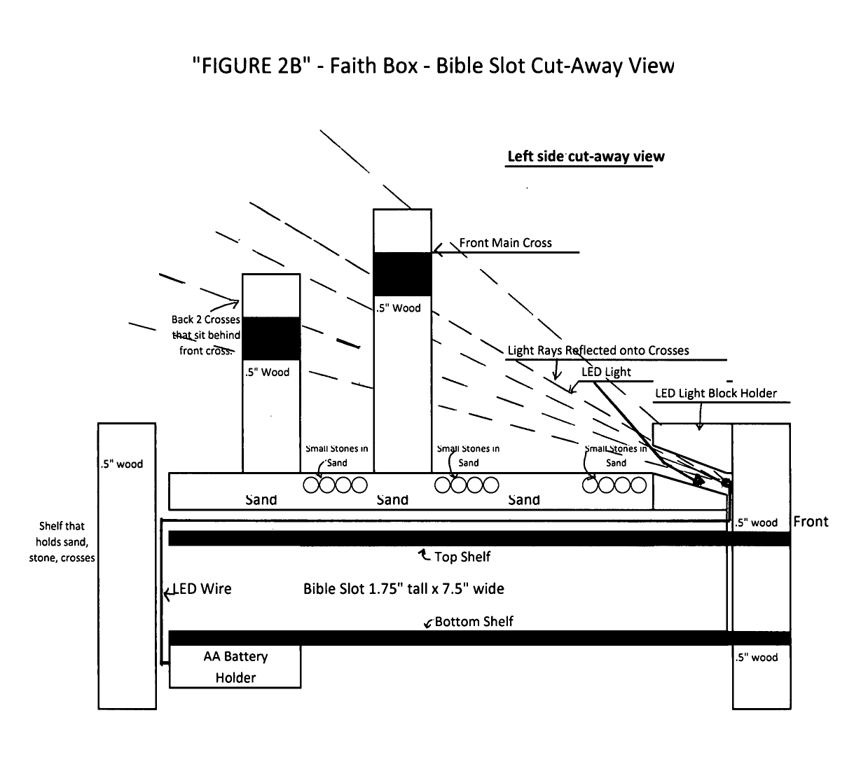

“FIG. 2A”—Faith Box—Bible Slot Front View:

### Wooden Stained Box

Poplar wood
4″ tall×8″ wide×9″ deep

Includes a shelf approximately 1.5 inches down from the top which also creates a four sided cavity 1.5 inches deep.

In the cavity one cup of white sand is the base, and six (6) irregularly shaped stones of various size, texture, and color are placed in the sand.

Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.

A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.

Electrical component for the LED light consists of:
LED light
10 ohm resistor
22 gauge wire
AA battery holder
On/off switch

This LED light illuminates the crosses which reflect up on the background. The size of the reflection on the wall varies according to the distance the Faith Box is located from the wall.

There is an opening 2″ down from the top on the front of the wood box to store a Bible. The opening is approximately 1.75 inches×6.75 inches×7″ deep.

“FIG. 2B”—Faith Box—Bible Slot Cut-Away View:

Description is same as FIG. 2A, but this view shows the left side cut-away/cross section view. Also, shown is the direction the LED light is on the cross, and the battery holder under the base.

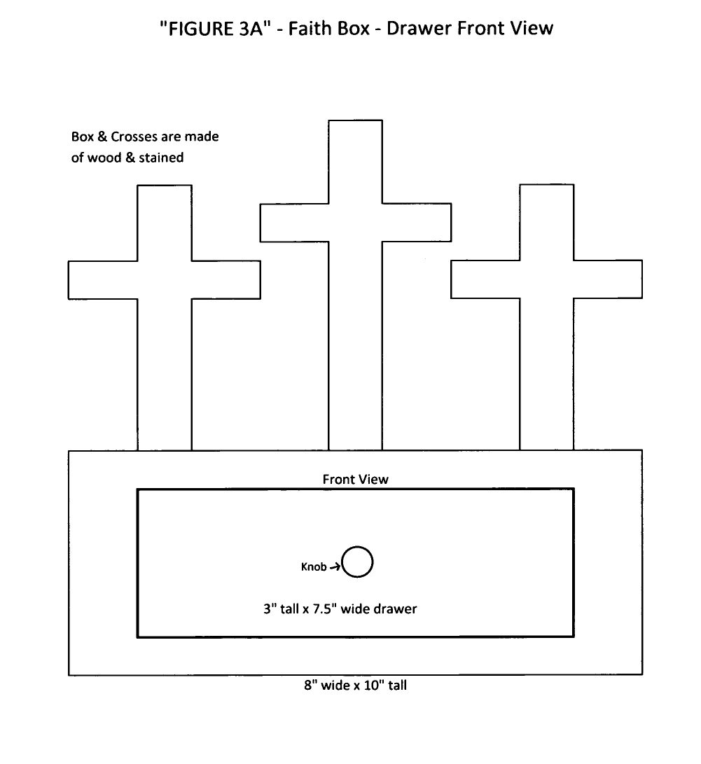

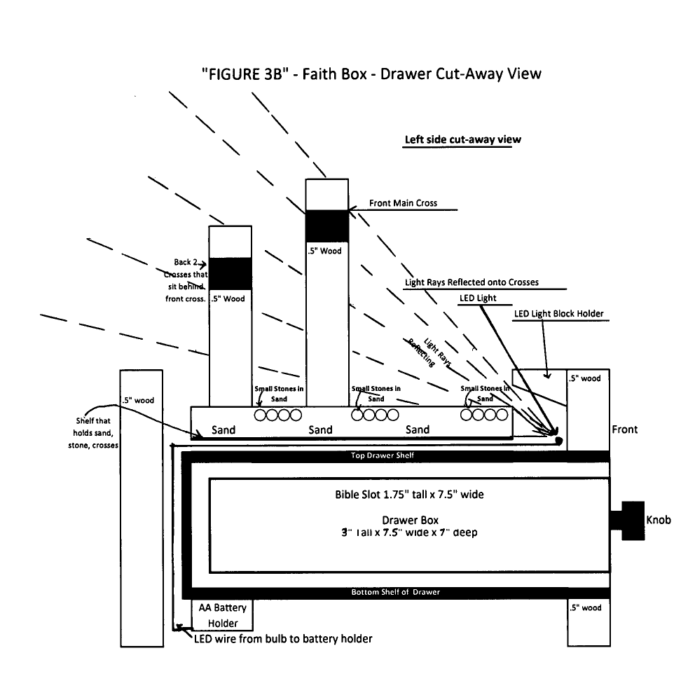

“FIG. 3A”—Faith Box—Drawer Front View:

### Wooden Stained Box

Poplar wood
5.25″ tall×8″ wide×9″ deep

Includes a shelf approximately 1.5 inches down from the top which also creates a four sided cavity 1.5 inches deep.

In the cavity one cup of white sand is the base, and six (6) irregularly shaped stones of various size, texture, and color are placed in the sand.

Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.

A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.

Electrical component for the LED light consists of:
LED light
10 ohm resistor
22 gauge wire
AA battery holder
On/off switch

This LED light illuminates the crosses which reflect up on the background. The size of the reflection on the wall varies according to the distance the Faith Box is located from the wall.

There is a 7″ wide×2.5″ tall×7″ deep drawer with a pull knob located on the front of the box approximately 2″ down from the top.

“FIG. 3B”—Faith Box—Drawer Cut-Away View:

Description is same as FIG. 3A, but this view shows the left side cut-away/cross section view. Also, shown is the direction the LED light is on the cross, and the battery holder under the base.

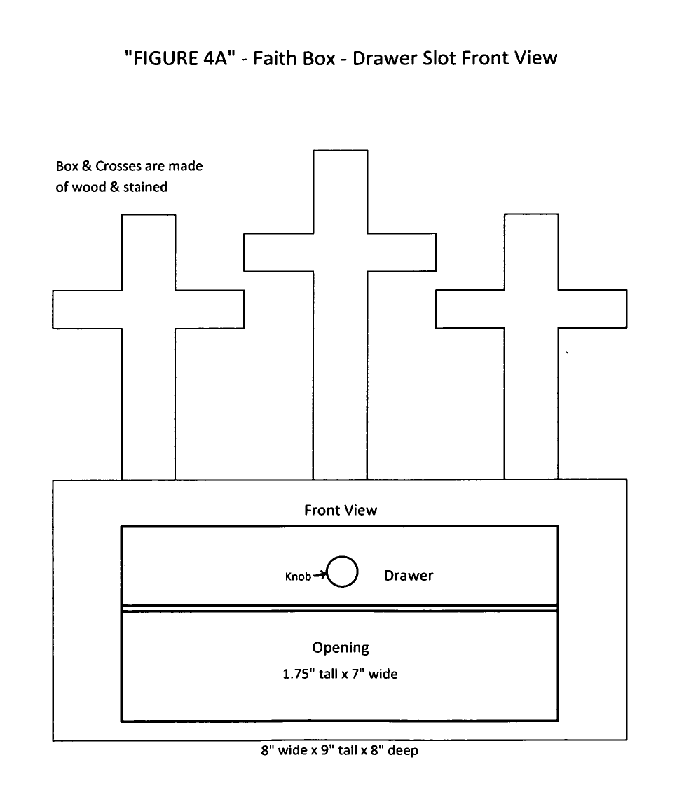

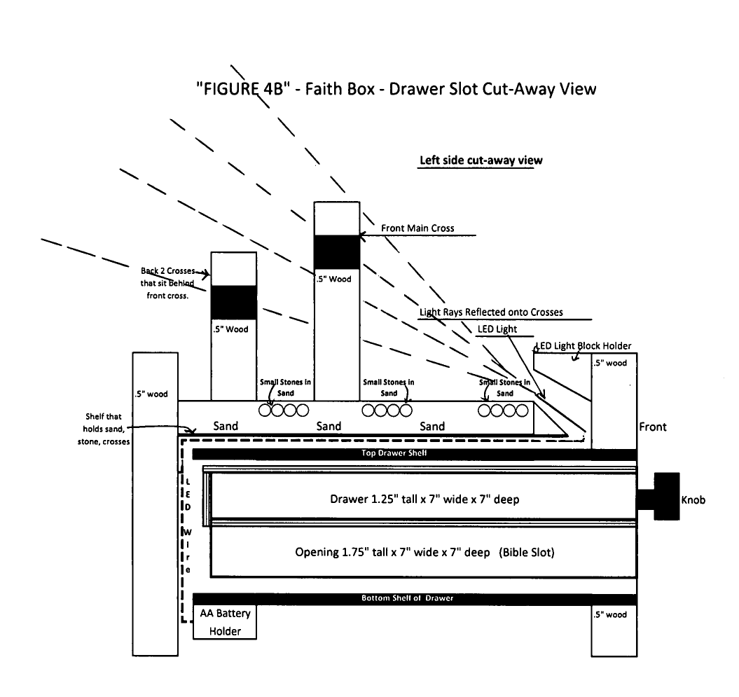

“FIG. 4A”—Faith Box—Drawer Slot Front View:

### Wooden Stained Box

Poplar wood
5.25″ tall×8″ wide×9″ deep

Includes a shelf approximately 1.5 inches down from the top which also creates a four sided cavity 1.5 inches deep.

In the cavity one cup of white sand is the base, and six (6) irregularly shaped stones of various size, texture, and color are placed in the sand.

Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.

A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.

Electrical component for the LED light consists of:
LED light
10 ohm resistor
22 gauge wire
AA battery holder
On/off switch

This LED light illuminates the crosses which reflect up on the background. The size of the reflection on the wall varies according to the distance the Faith Box is located from the wall.

There is a 7″ wide×1.5″ tall×7″ deep drawer with a pull knob located on the front of the box approximately 2″ down from the top. Under the drawer is an opening for a Bible 1.75″ tall×7″ wide×7″ deep.

“FIG. 4B”—Faith Box—Drawer Cut-Away View:

Description is same as FIG. 4A, but this view shows the left side cut-away/cross section view. Also, shown is the direction the LED light is on the cross, and the battery holder under the base.

1. Faith Box—Basic
Wooden Stained Box
Poplar wood
2.25″ tall×8″ wide×9″ deep
Includes a shelf approximately 1.5 inches down from the top which also creates a four sided cavity 1.5 inches deep.
In the cavity one cup of white sand is the base, and six (6) irregularly shaped stones of various size, texture, and color are placed in the sand.
Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.
A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.
Electrical component for the LED light consists of:
LED light
10 ohm resistor
22 gauge wire
AA battery holder
On/off switch
This LED light illuminates the crosses which reflect up on the background. The size of the reflection on the wall varies according to the distance the Faith Box is located from the wall.

2. Faith Box—Bible Slot
Wooden Stained Box
Poplar wood
4″ tall×8″ wide×9″ deep
Includes a shelf approximately 1.5 inches down from the top which also creates a four sided cavity 1.5 inches deep.
In the cavity one cup of white sand is the base, and six (6) irregularly shaped stones of various size, texture, and color are placed in the sand.
Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.
A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf
Electrical component for the LED light consists of:
LED light
10 ohm resistor
22 gauge wire
AA battery holder
On/off switch
This LED light illuminates the crosses which reflect up on the background. The size of the reflection on the wall varies according to the distance the Faith Box is located from the wall.
There is an opening 2″ down from the top on the front of the wood box to store a Bible. The opening is approximately 1.75 inches×6.75 inches×7″ deep.

3. Faith Box—Drawer
Wooden Stained Box
Poplar wood
5.25″ tall×8″ wide×9″ deep
Includes a shelf approximately 1.5 inches down from the top which also creates a four sided cavity 1.5 inches deep.
In the cavity one cup of white sand is the base, and six (6) irregularly shaped stones of various size, texture, and color are placed in the sand.
Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.
A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.
Electrical component for the LED light consists of:
LED light
10 ohm resistor
22 gauge wire
AA battery holder
On/off switch
This LED light illuminates the crosses which reflect up on the background. The size of the reflection on the wall varies according to the distance the Faith Box is located from the wall.
There is a 7″ wide×2.5″ tall×7″ deep drawer with a pull knob located on the front of the box approximately 2″ down from the top.

4. Faith Box—Drawer Slot
Wooden Stained Box
Poplar wood
5.25″ tall×8″ wide×9″ deep
Includes a shelf approximately 1.5 inches down from the top which also creates a four sided cavity 1.5 inches deep.
In the cavity one cup of white sand is the base, and six (6) irregularly shaped stones of various size, texture, and color are placed in the sand.
Four inches back from the front of the box and centered is the first cross. This cross is 5″ tall and 3″ wide. It is mounted in the cavity by a screw. There are two smaller crosses mounted by screws in the cavity behind the front cross. They are approximately 4″ tall and 3″ wide. The two smaller crosses are lined up parallel, off-centered, equally to the front cross.
A strip (1″×7″) of the same, stained Poplar wood is placed at the front of the cavity which includes an LED light centered and angled upward 45 degrees to shine on the front main cross. The LED light is powered by two AA batteries/holder with an on/off switch located underneath the shelf.
Electrical component for the LED light consists of:
LED light
10 ohm resistor
22 gauge wire
AA battery holder
On/off switch
This LED light illuminates the crosses which reflect up on the background. The size of the reflection on the wall varies according to the distance the Faith Box is located from the wall.
There is a 7″ wide×1.5″ tall×7″ deep drawer with a pull knob located on the front of the box approximately 2″ down from the top. Under the drawer is an opening for a Bible 1.75″ tall×7″ wide×7″ deep.
